(19) United States
(12) Patent Application Publication
(10) Pub. No.: US 2024/0253559 A1
(43) Pub. Date: Aug. 1, 2024

(54) VEHICLE DOOR STRUCTURE

(71) Applicant: HONDA MOTOR CO., LTD., Tokyo (JP)

(72) Inventors: Atsushi NAKASHIMA, Tokyo (JP); Mitsunori NISHINO, Tokyo (JP)

(21) Appl. No.: 18/403,853

(22) Filed: Jan. 4, 2024

(30) Foreign Application Priority Data
Jan. 27, 2023 (JP) 2023-011314

(51) Int. Cl. B60Q 3/217; B60J 5/04

(52) U.S. Cl. CPC B60Q 3/217; B60J 5/04

(57) ABSTRACT

A vehicle door structure includes: a door opened or closed through swinging with respect to a vehicle body; an illuminator arranged at the door; and an angle detector to detect an opening angle of the door with respect to the vehicle body, wherein the illuminator changes a door-based range of illumination with light, based on a result detected by the angle detector.

### CROSS-REFERENCE TO RELATED APPLICATION

This application claims the benefit of priority under 35 U.S.C. § 119 to Japanese Patent Application No. 2023-011314 filed on Jan. 27, 2023, the entire contents of which are incorporated herein by reference.

### TECHNICAL FIELD

The present invention relates to a door of a vehicle.

### BACKGROUND OF THE INVENTION

Efforts have been actively made in recent years to provide access to sustainable transportation systems friendly to vulnerable transportation participants, such as the elderly, disabled people, and children. To this end, efforts in research and development have been focused on further improving safety and convenience in transportation through innovations on user-friendliness while an occupant getting in and out of a vehicle.

Japanese Patent Application Publication No. H05-338499A (hereinbelow, referred to as Patent Document 1), for example, discloses a structure of a vehicle door, with a step lamp provided at a door lining. The step lamp illuminates the ground under a door with light to shine light on feet of an occupant, so as to assist the occupant in getting in or out of the vehicle.

### SUMMARY

### Problems to be Solved

The structure of Patent Document 1 has such a problem that an orientation of the step lamp changes with an opening angle of the door to follow the door, so that a range of illumination with light by the step lamp moves when referenced to a vehicle body.

The present invention has been devised in view of the above-identified problem and is intended to provide a vehicle door structure to illuminate a suitable range even when an opening angle of the door is changed, and thus to contribute to advancement of sustainable transportation systems.

### Solution to Problems

A vehicle door structure according to the present invention, to solve the above-identified problem, includes: a door opened or closed through swinging with respect to a vehicle body; an illuminator provided at the door; and an angle detector to detect an opening angle of the door with respect to the vehicle body, wherein the illuminator changes a door-based range of illumination with light, based on a result detected by the angle detector.

### Advantageous Effects of the Invention

The present invention provides a vehicle door structure to illuminate a suitable range even when an opening angle of the door is changed, and thus to contribute to advancement of sustainable transportation systems.

### BRIEF DESCRIPTION OF DRAWINGS

FIG. 1 is a schematic top view of a vehicle with a vehicle illumination system according to a first embodiment of the present invention;

FIG. 2 is a cross-sectional view of the vehicle illumination system, taken along a line II-II in FIG. 1;

FIG. 3 is a schematic block diagram of the vehicle illumination system according to the first embodiment of the present invention;

FIG. 4 is a schematic top view of a range of illumination vs an opening state (almost closed) of a door with the vehicle illumination system according to the first embodiment of the present invention;

FIG. 5 is a schematic top view of a range of illumination vs an opening state (half closed) of the door with the vehicle illumination system according to the first embodiment of the present invention;

FIG. 6 is a schematic top view of a range of illumination vs an opening state (fully opened) of the door with the vehicle illumination system according to the first embodiment of the present invention;

FIG. 7 is a schematic block diagram of a vehicle illumination system according to a second embodiment of the present invention;

FIG. 8 is a schematic top view of a range of illumination vs an opening state (almost closed) of the door with the vehicle illumination system according to the second embodiment of the present invention;

FIG. 9 is a schematic top view of a range of illumination vs an opening state (half closed) of the door with the vehicle illumination system according to the second embodiment of the present invention;

FIG. 10 is a schematic top view of a range of illumination vs an opening state (fully opened) of the door with the vehicle illumination system according to the second embodiment of the present invention;
and

FIG. 11 is a schematic block diagram of a vehicle illumination system according to a third embodiment of the present invention.

### DETAILED DESCRIPTION

Hereinafter, a description is given in detail of embodiments of the present invention by way of an example where a vehicle door structure of the present invention is applied to a side door for a right front seat of a vehicle (driver seat in Japan), with reference to the drawings as required. Note that “a front-rear direction” in the drawings indicates a front-rear direction in a traveling direction of the vehicle or a vehicle front-rear direction, and “a right-left direction” indicates a right-left direction (a vehicle width direction) as viewed from a driver seat.

### First Embodiment

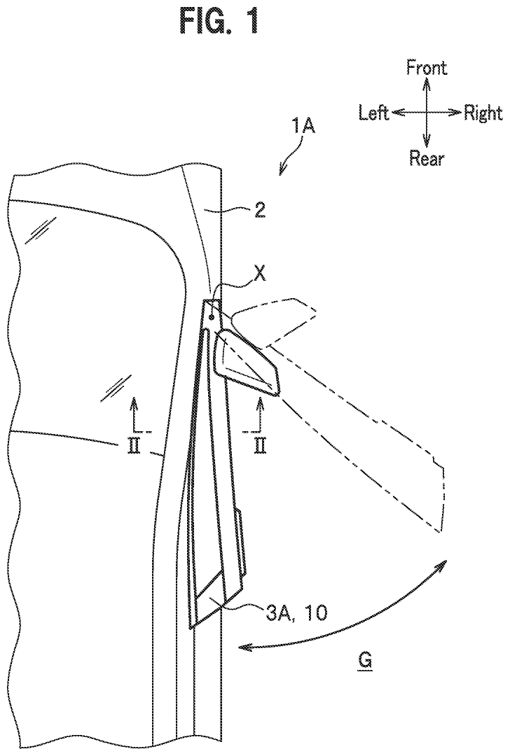

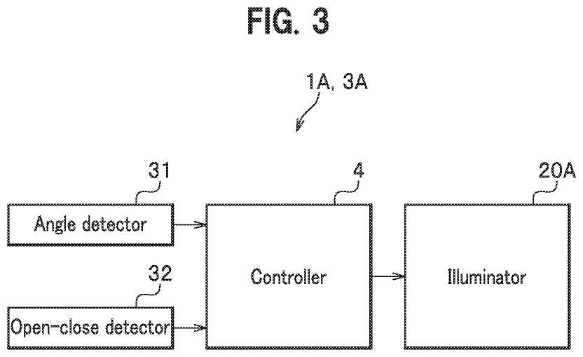

A vehicle illumination system 1A according to a first embodiment of the present invention includes a vehicle body 2, a vehicle door structure 3A provided to the vehicle body 2, and a controller 4 (see FIG. 3), as shown in FIG. 1.

### <Vehicle Door Structure>

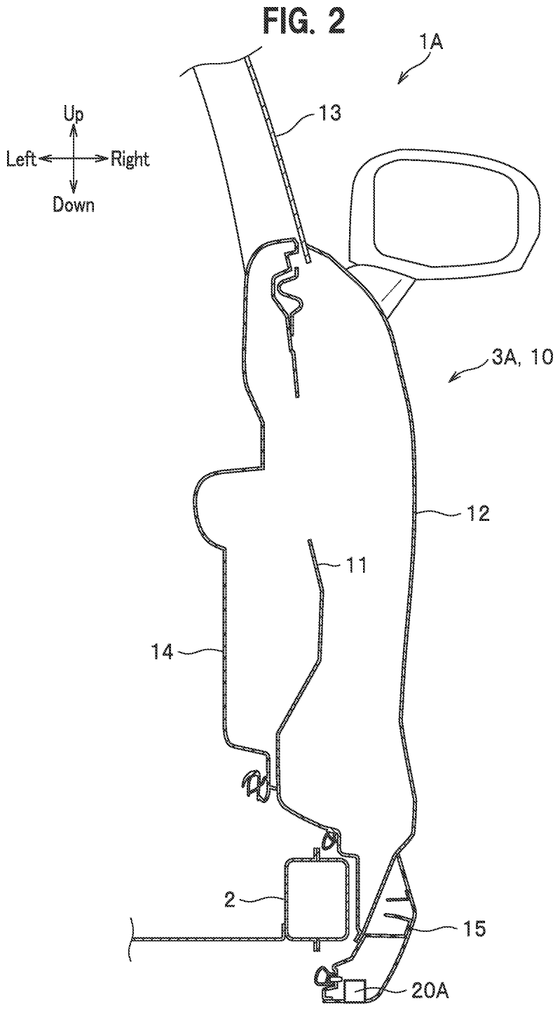

The vehicle door structure 3A includes a door 10, an illuminator 20A, an angle detector 31, and an open-close detector 32, as shown in FIGS. 2 and 3.

### <<Door>>

As shown in FIG. 2, the door 10 is provided so as to open and close an opening in a lateral face in the vehicle width direction of the vehicle body 2 (right lateral face in the present embodiment). The door 10 is attached so as to be swung about a front end thereof, as a pivot axis X extending in an up-down direction, with respect to the vehicle body 2, as viewed from the top. The door 10 includes an inner door panel 11, an outer door panel 12, a window 13, a door lining 14, and a lower door garnish 15.

The inner door panel 11 is a metal plate member to form an inner portion in the vehicle width direction of the door 10. The outer door panel 12 is a metal plate member to form an outer portion in the vehicle width direction of the door 10. The inner door panel 11 and the outer door panel 12 are joined to each other by hemming, welding, or the like, to constitute a door body.

The window (side window) 13 is a glass plate member to open and close an opening of the door body. The door lining (interior material) 14 is a resin plate member to cover an interior side of the inner door panel 11. A lower end of the door lining 14 is positioned higher than lower ends of the inner and outer door panels 11, 12.

The lower door garnish 15 is a resin member extending downward from the door body. The lower door garnish 15, together with the door body, defines a closed cross-section running in the front-rear direction. The lower door garnish 15 is positioned outer in the vehicle width direction than the vehicle body 2 when the door 10 is closed. The lower door garnish 15 has its bottom surface (i.e., the bottommost surface of the door 10) sticking out of the vehicle body 2 from end to end, as viewed from a ground G.

### <<Illuminator>>

The illuminator 20A is arranged within the lower door garnish 15 and illuminates the ground G under the door 10 with light through a window in the bottom surface of the lower door garnish 15 (i.e., the bottommost surface of the door 10). The illuminator 20A is configured to illuminate light on both an outer side and inner side in the vehicle width direction of the door 10 from the bottommost surface of the door 10. In the present embodiment, the illuminator 20A is composed of two or more LEDs (Light-Emitting Diodes) and is a projection light capable of projecting various images based on a control signal from the controller 4. Note that the step lamp in the structure of Patent Document 1 illuminates light from an inner surface in the vehicle width direction of the door lining, instead of the bottommost surface of the door, and thus cannot illuminate light on an outer side in the vehicle width direction of the door.

### <<Angle Detector>>

The angle detector 31 is a sensor to detect an opening angle (also referred to as an opening degree and including parameters correlating with the opening angle) of the door 10 with respect to the vehicle body 2 and output a detected result to the controller 4.

### <<Open-Close Detector>>

The open-close detector 32 is a sensor to detect whether the door 10 is closed (fully closed) or open and output a detected result to the controller 4. In the present embodiment, the open-close detector 32 detects a state of a latch mechanism (not shown) to fix the door 10 to the vehicle body 2, as to whether the door 10 is open or closed.

### <<Controller>>

The controller 4 is a so-called ECU (Electronic Control Unit) including a CPU (Central Processing Unit), a ROM (Read-Only Memory), a RAM (Random Access Memory), and an input-output circuit. The controller 4 controls the illuminator 20A based on the result detected by the open-close detector 32. The controller 4 turns off the illuminator 20A when the result detected by the open-close detector 32 indicates as being closed (fully closed), while turns on the illuminator 20A when the result detected by the open-close detector 32 indicates as being open.

Additionally, the controller 4 controls turning on the illuminator 20A when the result detected by the open-close detector 32 indicates as being open, based on a result detected by the angle detector 31.

The controller 4 controls the illuminator 20A, based on the result detected by the angle detector 31, to illuminate light on the ground G in a sector-shaped range R of illumination indicating an entire swing range (pivot range, moving range) from a state of the door 10 being fully closed (opening angle of zero degrees) to a state of the door 10 being fully opened. In the present embodiment, the swing range of the door 10, corresponding to the range R of illumination, is based on a state of the door 10 being fully closed and a state of the door 10 being fully opened, which are determined by a structure (such as a hinge and a stopper) of the pivot axis X for the door 10.

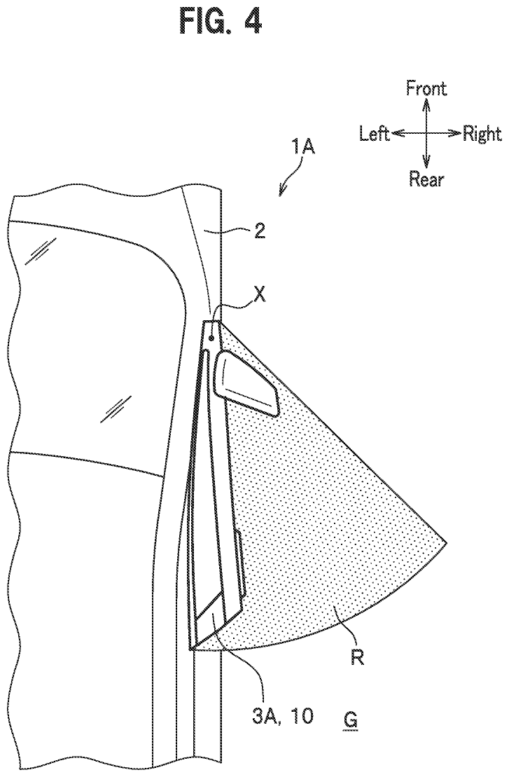

For example, when the door 10 is slightly opened from a state of the door 10 being closed (fully closed), the illuminator 20A illuminates light on the ground G in the range R of illumination indicating an entire swing range from a state of the door 10 being fully closed to a state of the door 10 being fully opened, as shown in FIG. 4. In this case, the illuminator 20A illuminates light on an outer side in the vehicle width direction of the door 10.

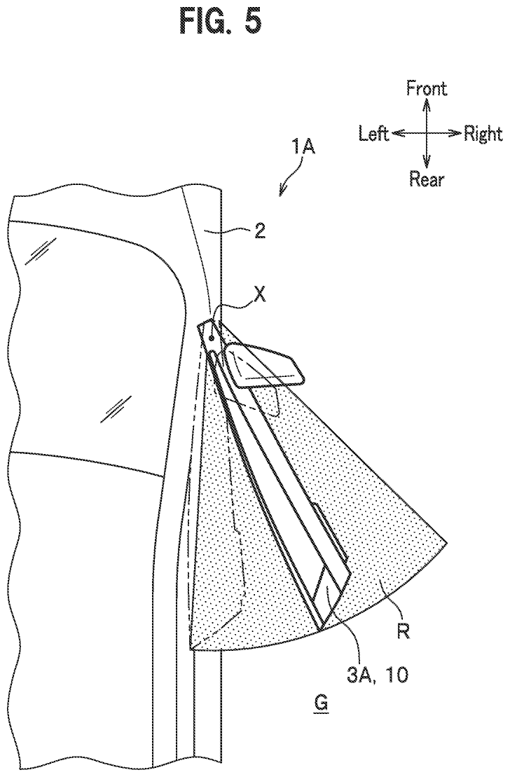

Even when the door 10 is opened (half opened), the illuminator 20A also illuminates light on the ground G in the range R of illumination indicating the entire swing range from a state of the door 10 being fully closed to a state of the door 10 being fully opened, as shown in FIG. 5. In this case, the illuminator 20A illuminates light on both an outer side and inner side in the vehicle width direction of the door 10.

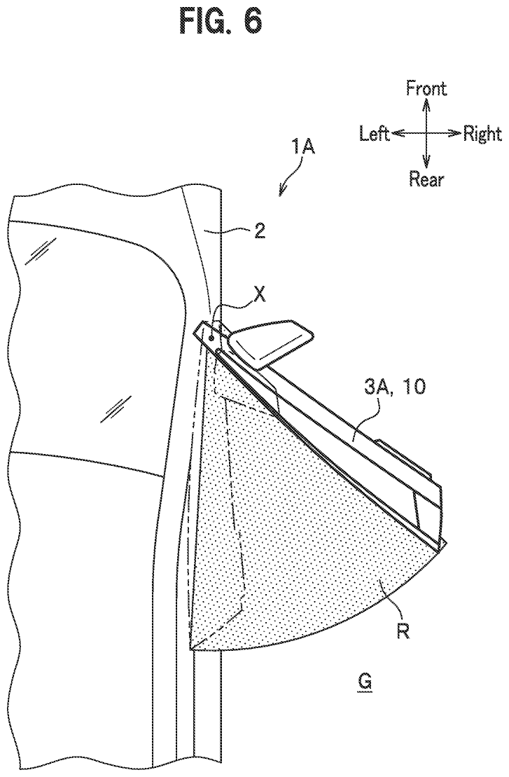

Even when the door 10 is opened (fully opened), the illuminator 20A also illuminates light on the ground G in the range R of illumination indicating the entire swing range from a state of the door 10 being fully closed to a state of the door 10 being fully opened, as shown in FIG. 6. In this case, the illuminator 20A illuminates a light on an inner side in the vehicle width direction of the door 10. Note that the range R of illumination is displaced from the door 10 in FIG. 6 for the purpose of illustration (this also happens in one or more drawings referenced below).

That is, the illuminator 20A changes a door 10-based range of illumination, through control by the controller 4 based on the result detected by the angle detector 31, to have the vehicle body 2-based range R of illumination staying constant.

The vehicle door structure 3A according to the first embodiment of the present invention includes: the door 10 opened or closed through swinging with respect to the vehicle body 2; the illuminator 20A provided at the door 10; and the angle detector 31 to detect an opening angle of the door 10 with respect to the vehicle body 2, wherein the illuminator 20A changes the door 10-based range of illumination with light, based on a result detected by the angle detector 31. Accordingly, the vehicle door structure 3A illuminates a suitable range with light even when the opening angle of the door 10 is changed, and thus contributes to advancement of sustainable transportation systems.

In addition, the illuminator 20A of the vehicle door structure 3A changes a door 10-based range of illumination with light, based on the result detected by the angle detector 31, so as to have the vehicle body 2-based range R of illumination with light staying constant. Accordingly, the vehicle door structure 3A illuminates the same range with light even when the opening angle of the door 10 is changed

Further, the illuminator 20A of the vehicle door structure 3A illuminates light on an entire swing range of the door 10, as the vehicle body 2-based range R of illumination with light. Accordingly, the vehicle door structure 3A suitably notifies the occupant of a pivoting range of the door 10 and shines light on the feet of the occupant, to suitably assist the occupant in getting in or out of the vehicle. More in detail, when the occupant opens the door 10 from outside of the vehicle, the vehicle door structure 3A suitably notifies the occupant of a range of the door 10 being swung. When the occupant opens the door 10 and gets in the vehicle, the vehicle door structure 3A suitably shines light on the feet of the occupant. When the occupant has gotten in the vehicle and closes the door 10, the vehicle door structure 3A suitably notifies the occupant and one or more people outside the vehicle of a range of the door 10 being swung. When the occupant opens the door 10 and gets out of the vehicle, the vehicle door structure 3A suitably notifies the occupant and one or more people outside the vehicle of a range of the door 10 being swung. When the occupant closes the door 10 from outside of the vehicle, the vehicle door structure 3A suitably notifies the occupant of a range of the door 10 being moved.

Furthermore, the illuminator 20A of the vehicle door structure 3A illuminates light on the outer side and inner side in the vehicle width direction of the door 10 from the bottommost surface of the door 10. Accordingly, the vehicle door structure 3A suitably illuminates both the outer side and inner side in the vehicle width direction of the door 10, to allow for illuminating light on a suitable range even when an opening angle of the door 10 is changed.

### Second Embodiment

Next, a description is given of a vehicle illumination system according to a second embodiment of the present embodiment, focusing on differences from the vehicle illumination system 1A according to the first embodiment.

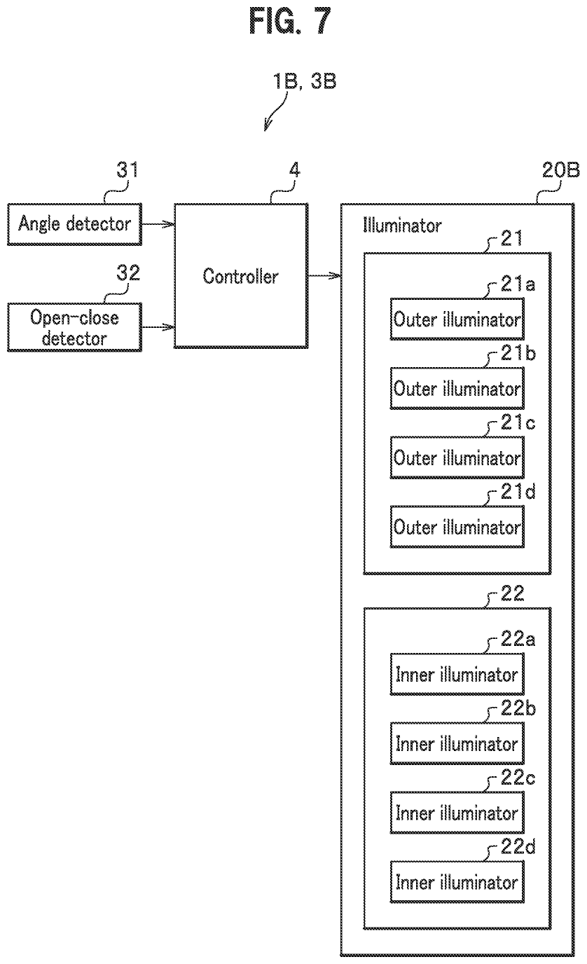

As shown in FIG. 7, a vehicle illumination system 1B according to the second embodiment of the present invention includes a vehicle door structure 3B in place of the vehicle door structure 3A. The vehicle door structure 3B includes an illuminator 20B in place of the illuminator 20A.

### <<Illuminator>>

The illuminator 20B includes a plurality of (four in the present embodiment) outer illuminators 21 (21a, 21b, 21c, 21d) and a plurality of (four in the present embodiment) inner illuminators 22 (22a, 22b, 22c, 22d).

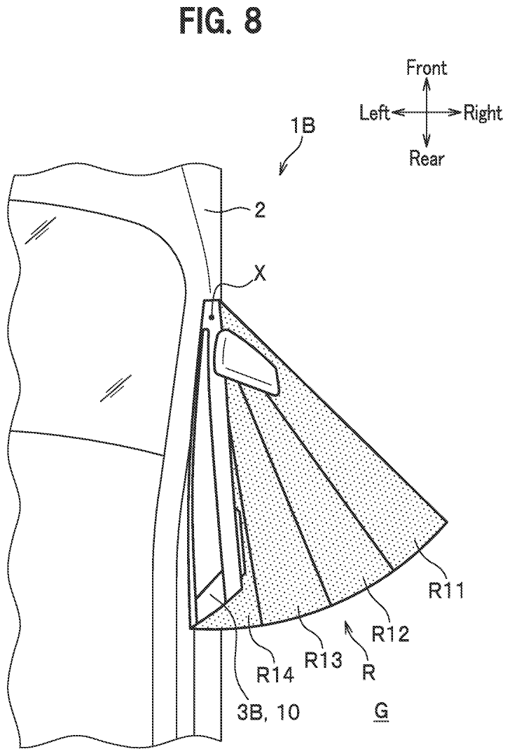

The outer illuminator 21 illuminates light on an outer area in the vehicle width direction than the door 10. The outer illuminator 21a illuminates light on a door 10-based range R11 of illumination (see FIG. 8). The outer illuminator 21b illuminates light on a door 10-based range R12 of illumination (see FIG. 8). The outer illuminator 21c illuminates light on a door 10-based range R13 of illumination (see FIG. 8). The outer illuminator 21d illuminates light on a door 10-based range R14 of illumination (see FIG. 8). As shown in FIG. 8, the ranges R11, R12, R13, R14 are each in a sector shape into which the range R is circumferentially divided.

As shown in FIG. 10, the inner illuminator 22 illuminates light on an inner area in the vehicle width direction than the door 10. The inner illuminator 22a illuminates light on a door 10-based range R21 of illumination (see FIG. 10). The inner illuminator 22b illuminates light on a door 10-based range R22 of illumination (see FIG. 10). The inner illuminator 22c illuminates light on a door 10-based range R23 of illumination (see FIG. 10). The inner illuminator 22d illuminates light on a door 10-based range R24 of illumination (see FIG. 10). As shown in FIG. 10, the ranges R21, R22, R23, R24 are each in a sector shape into which the range R is circumferentially divided.

As shown in FIG. 10, the controller 4 controls the illuminator 20B based on a result detected by the angle detector 30, to cause the illuminator 20B to illuminate light on the ground G in the range R indicating the entire swing range (pivot range, moving range) from a state of the door 10 being fully closed to a state of the door 10 being fully opened, inclusive of an area right under the door 10.

For example, when the door 10 is slightly opened from a state of the door 10 being closed (fully closed), the illuminator 20B is controlled to have the outer illuminators 21a, 21b, 21c, 21d turned on and the inner illuminators 22a, 22b, 22c, 22d turned off, as shown in FIG. 8. This causes the ranges R11, R12, R13, R14 of illumination by the outer illuminators 21a, 21b, 21c, 21d to form the range R of illumination indicating the entire swing range from a state of the door 10 being fully closed to a state of the door 10 being fully opened.

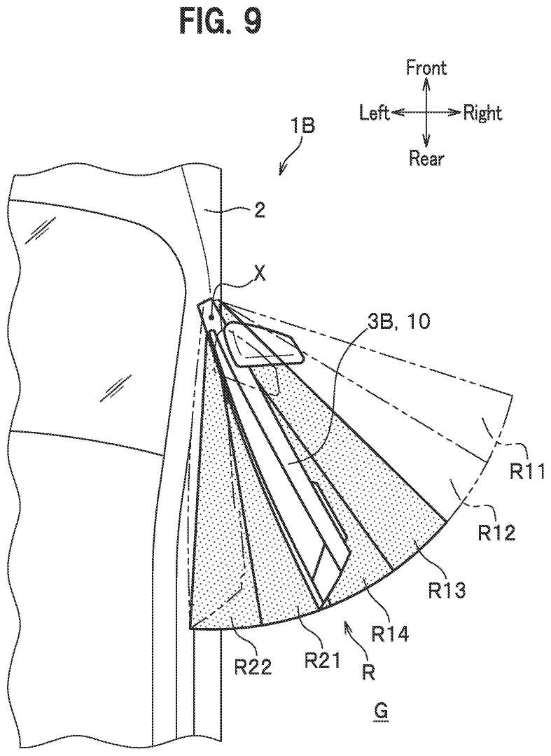

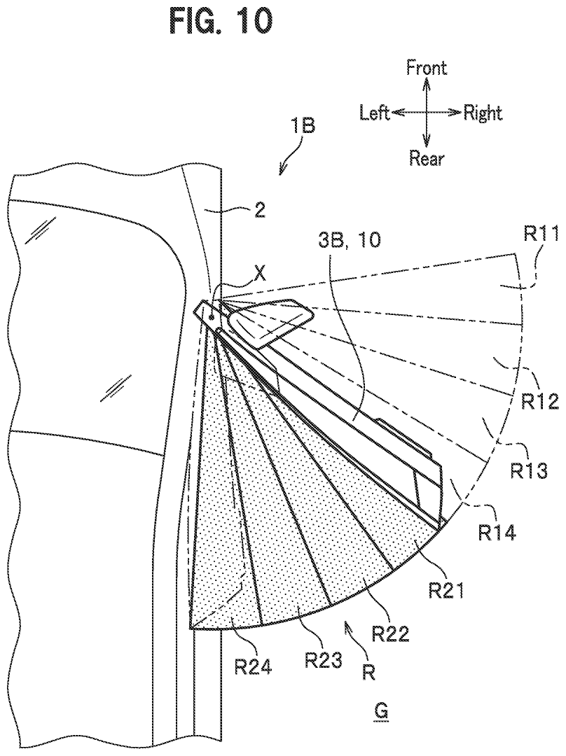

Additionally, when the door 10 is opened (half opened), the illuminator 20B is controlled to have the outer illuminators 21c, 21d and inner illuminators 22a, 22b turned on, while the outer illuminators 21a, 21b and inner illuminators 22c, 22d turned off, as shown in FIG. 9. This causes the ranges R13, R14, R21, R22 of illumination by the outer illuminators 21c, 21d and inner illuminators 22a, 22b to form the range R indicating the entire swing range from a state of the door 10 being fully closed to a state of the door 10 being fully opened.

Likewise, when the door 10 is opened (fully opened), the illuminator 20B is controlled to have the outer illuminators 21a, 21b, 21c, 21d turned off and the inner illuminators 22a, 22b, 22c, 22d turned on, as shown in FIG. 10. This causes the ranges R21, R22, R23, R24 of illumination by the inner illuminators 22a, 22b, 22c, 22d to form the range R indicating the entire swing range from a state of the door 10 being fully closed to a state of the door 10 being fully opened.

The vehicle door structure 3B according to the second embodiment of the present embodiment achieves the same advantageous effects as those by the vehicle door structure 3A according to the first embodiment by turning on/off the plurality of illuminators 21 and 22.

### Third Embodiment

Next, a description is given of a vehicle illumination system according to a third embodiment of the present embodiment, focusing on differences from the vehicle illumination system 1A according to the first embodiment.

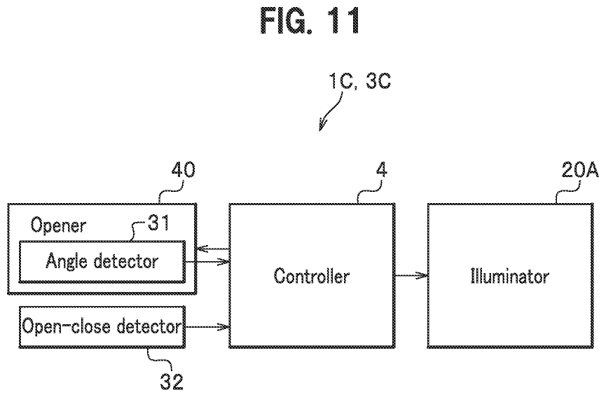

As shown in FIG. 11, a vehicle illumination system 1C according to the third embodiment of the present invention includes a vehicle door structure 3C in place of the vehicle door structure 3A. The vehicle door structure 3C includes an opener 40.

### <<Opener>>

The opener 40 opens and closes (swing) the door 10, based on a control signal from the controller 4. The angle detector 31 is provided in the opener 40 and is a sensor to count pulses of a motor of the opener 40, for example, as a parameter correlating with an opening angle, and output a counting result to the controller 4. The controller 4 calculates the opening angle of the door 10, based on the counting result.

Such a device may be applied as the opener 40 that includes a spindle screw supported by the vehicle body 2 so as to be swingable, a spindle nut provided at the door 10 and screwed onto the spindle screw, and a motor provided at the door 10 and coupled with the spindle nut via a speed reduction mechanism.

The swing range of the door 10 in the present embodiment, corresponding to the range R of illumination, is a range defined by a state of the door 10 being fully closed and a state of the door 10 being fully opened through control of the door 10 (the state of the door 10 being fully closed is determined by a structure of the pivot axis X for the door 10, as with the first embodiment), and is set to the swing range in the first embodiment or less. A state of the door 10 being fully opened may be determined by specification of the opener 40 or may be determined by a desired opening angle (desired opening degree) for automatic open-close control of the door 10 by the controller 4, using a result detected by the angle detector 31.

The vehicle door structure 3C according to the third embodiment of the present invention includes the opener 40 to open and close the door 10, and the angle detector 31 is provided in the opener 40. Accordingly, the vehicle door structure 3C has reduced parts in number by using the angle detector 31 also as the sensor in the opener 40.

Hereinabove, the embodiments of the present invention have been described, but the present invention is not limited thereto and can be modified as required within a scope thereof. For example, the vehicle door structure may have the second embodiment combined with the third embodiment. In addition, the illuminator 20A or 20B may be provided at the door body, the door lining 14, or the like, depending on a structure of the door 10, as far as being provided on the bottommost surface of the door 10. Further, the illuminator 20A or 20B may illuminate the ground G with light in a form of an outline of the range R of illumination, as a range of illumination, or may illuminate the ground G with light in a form of a radially extending line (line indicating a radius) out of the outline of the range R of illumination, corresponding to a state of the door 10 being fully opened, as a range of illumination. Still further, the number of the outer illuminators 21 and inner illuminators 22 of the illuminator 20B are not limited to those described above and the greater the number is, the more accurately the range R of illumination is set. Still further, materials of the members of the door 10 are not limited to those described above.

Still further, the controller 4 may be configured to set the range R of illumination, when the door 10 is manually opened and closed, so as to have the swing range of the door 10 determined by a structure of the pivot axis X, while to set the range R of illumination, when the door 10 is automatically opened and closed, so as to have the swing range of the door 10 controlled by itself. Still further, the controller 4 may be configured to set the range R of illumination, when the door 10 is manually opened and closed and has an assist force given by the opener 40, so as to have the swing range of the door 10 falling within a range where the assist force is given. The controller 4 is capable of determining whether the door 10 is automatically opened and closed or manually (inclusive of a case where an assist force is given) opened and closed, based on a result of a user having operated an operating unit (such as an intelligent key), not shown, and executing control based on a result of the determination.

### LIST OF REFERENCE SIGNS

1A, 1B, 1C, vehicle illumination system; 2, vehicle body; 3A, 3B, 3C, vehicle door structure; 4, controller; 10, door; 20A, 20B, illuminator; 31, angle detector; 40, opener; and R, range of illumination.

What is claimed is:

1. A vehicle door structure comprising:
a door opened or closed through swinging with respect to a vehicle body;
an illuminator arranged at the door; and
an angle detector to detect an opening angle of the door with respect to the vehicle body,
wherein the illuminator changes a door-based range of illumination with light, based on a result detected by the angle detector.

2. The vehicle door structure according to claim 1, wherein
the illuminator changes the door-based range of illumination with light, based on a result detected by the angle detector, so as to have a vehicle body-based range of illumination with light staying constant.

3. The vehicle door structure according to claim 2, wherein
the illuminator illuminates light on an entire swing range of the door, as the vehicle body-based range of illumination with light.

4. The vehicle door structure according to claim 1, wherein
the illuminator illuminates light on an outer side and inner side in a vehicle width direction of the door from the bottommost surface of the door.

5. The vehicle door structure according to claim 1, further comprising:
an opener to open and close the door,
wherein the angle detector is provided in the opener.
